(19) United States
(12) Patent Application Publication
(10) Pub. No.: US 2026/0336630 A1
(43) Pub. Date: Oct. 29, 2026

(54) METHOD AND SYSTEM FOR DETECTING AN AQUAPLANING CONDITION OF A TYRE ON A SURFACE

(71) Applicant: Pirelli Tyre S.p.A, Milano (IT)

(72) Inventors: Gabriele MONTORIO, Milano (IT); Elvis Villano, Milano (IT)

(73) Assignee: Pirelli Tyre S.p.A, Milano (IT)

(21) Appl. No.: 19/587,852

(22) PCT Filed: Nov. 27, 2024
(86) PCT No.: PCT/IT2024/050245

§ 371 Date: May 15, 2026

(30) Foreign Application Priority Data
Dec. 1, 2023 (IT) 102023000025719

(51) Int. Cl. B60W 40/06; B60W 50/00

(52) U.S. Cl. CPC B60W 40/06; B60W 50/00; B60W 2050/0049; B60W 2050/0088

(57) ABSTRACT

Method and system (99) for detecting an aquaplaning condition (IC) of a tyre (3) with a surface (900), wherein the system (99) comprises a monitoring device (4) fixed to an inner surface (5) of the tyre (3) at a crown portion (6) and configured to acquire a radial acceleration signal (AS) from the crown portion (6), and a processing unit (8) in communication with the monitoring device (4) and programmed to receive from the monitoring device (4) the radial acceleration signal (AS) and to perform the following steps of the method: obtaining an adjustment factor (Af) representative of an offset between one or more acquired values of radial acceleration and respective current values; obtaining an adjusted radial acceleration signal (ASa) by a difference between the radial acceleration signal (AS) and the adjustment factor (Af); identifying, in the adjusted radial acceleration signal (ASa), a sub-portion (ASaP) of the signal corresponding to a passage of the crown portion (6) internally to a footprint portion of the tyre (3); calculating a comparison parameter (RV) as a function of an average value (mASa) of the signal (ASa) in the sub-portion (ASaP); detecting the aquaplane condition (IC) as a function of a comparison between the comparison parameter (RV) and at least one threshold value.

### TECHNICAL FIELD OF THE INVENTION

The present invention relates to a method and a system for detecting an aquaplaning condition of a tyre on a surface. The present invention further relates to a vehicle comprising the detection system.

### STATE OF THE ART

Typically a tyre has a structure that is substantially toroidal around an axis of rotation thereof during operation, and presents an equatorial plane orthogonal to the axis of rotation, said equatorial plane being typically a plane of (substantial) geometric symmetry (e.g., neglecting any minor asymmetries, such as the tread pattern and/or the markings on the sidewalls and/or the internal structure).

By “crown portion” it is meant a portion of tyre located at the tread band.

The term “radial” is used with reference to a perpendicular direction to the axis of rotation of the tyre.

By “footprint” it is meant the portion of the outer surface of the tread band which, during the rolling of the mounted tyre subjected to a load (for example, due to mounting on a vehicle), is at any given moment in contact with the rolling surface. The footprint typically has substantially null curvature (or a substantially infinite radius of curvature), or in any case, it substantially assumes the conformation of the rolling surface.

By “footprint portion” it is meant a respective crown portion corresponding (instantaneously) to the footprint.

The expression “lying internally” or “externally to the footprint portion,” referred to a crown portion means that, as a result of the rotation of the tyre, the respective crown portion comes to be located respectively inside or outside the footprint portion of the tyre at a given instant/time interval, or at a given (corresponding) angular position/angular interval.

By “passing internally to the footprint portion,” referred to the aforementioned crown portion, it is meant an interval, preferably whole, expressed for example in units of time or in degrees of rotation (e.g., relative to a full rotation), during which the crown portion, as a result of the rotation of the tyre, continuously lies inside the footprint portion of the tyre. The passage can also consist, for example, of a single moment in time or angular position wherein the crown portion coincides with the footprint portion in the case of the same surface extension (e.g., on the inner surface) of the two portions.

In the present context, by aquaplaning condition it is meant the condition in which a tyre, rolling on a surface, loses its grip with that surface, even to the point of completely losing it, due to the presence of a layer of water interposed between the tyre and the surface.

The aquaplaning condition typically occurs when the drainage and expulsion of water in the channels and/or grooves of the tread, at the footprint area, becomes insufficient to the point of causing an accumulation of water between the tyre and the surface, which is capable of lifting (to a greater or lesser extent) the tyre from the surface precisely at the footprint area.

Such lifting particularly causes a reduction in the footprint area, which in turn results in the aforementioned decrease in the grip of the tyre with the road surface, leading to a loss of directional control and traction by the tyre itself. The phenomenon of aquaplaning can be extremely dangerous, as under such conditions, the driver may essentially lose control of the vehicle and be unable to steer the vehicle, avoid obstacles, etc.

### SUMMARY OF THE INVENTION

In the aforementioned context, the Applicant observes that the detection of the aquaplaning condition, due to its potential danger, must be promptly carried out upon the occurrence of the condition itself, in order to promptly activate the active safety control systems of the vehicle.

For this same reason, it is of primary importance that the aquaplaning condition be detected as reliably as possible, in order to reduce the risk of incorrect detections (false positives) and, equally dangerous, if not even more dangerous, the failure to detect actual aquaplaning conditions (false negatives).

In the aforementioned context, the Applicant has realized that it is particularly advantageous to detect the aquaplaning condition of the tyre starting from the detection of a radial acceleration signal of a crown portion of such tyre, in particular of a desired sub-portion of this radial acceleration signal corresponding to a specific moment or time interval of a full rotation of the crown portion around an axis of the tyre (i.e., a full rotation of the wheel on which the tire is mounted).

As stated above, it also follows that it is of equal primary importance that the detected acceleration signal be as free from measurement errors as possible, in order to reliably detect the aquaplaning condition with the desired accuracy.

The Applicant has therefore addressed the problem of detecting an aquaplaning condition of a tyre on a surface in a simple, precise, reliable, and robust manner over time.

According to the Applicant, the aforementioned problem is solved by a method and a system for detecting an aquaplaning condition of a tyre on a surface, wherein it is provided to acquire a radial acceleration signal of a crown portion of the tyre, process the acquired signal to eliminate any measurement errors present and obtain an adequate signal, identify, in the adequate signal, a sub-portion of the signal corresponding to a passage of the crown portion into a footprint portion of the tyre, and detect the aquaplaning condition based on a comparison between an average value of the signal in the sub-portion and at least one threshold value.

According to one aspect, the invention relates to a method for detecting an aquaplaning condition of a tyre on a surface.

The method preferably comprises providing a monitoring device fixed on an inner surface of said tyre at a crown portion of said tyre.

The method preferably comprises acquiring, during a rolling of said tyre on said surface with an angular speed, a radial acceleration signal of said crown portion of said tyre by means of said monitoring device. Preferably, said radial acceleration signal comprises one or more acquired values of radial acceleration of said crown portion of said tyre.

The method preferably comprises obtaining an adjustment factor representative of an (average) offset between said one or more acquired values of radial acceleration and respective current values of radial acceleration of said crown portion.

In a first embodiment, the method preferably comprises:
obtaining an adjusted radial acceleration signal by a difference between said radial acceleration signal and said adjustment factor;
identifying, in said adjusted radial acceleration signal, a sub-portion of said adjusted radial acceleration signal corresponding to a passage of said crown portion internally to a footprint portion of said tyre.

In a second embodiment, the method preferably comprises:
identifying, in said radial acceleration signal, a respective sub-portion of said radial acceleration signal corresponding to a passage of said crown portion internally to a footprint portion of said tyre;
obtaining a sub-portion of an adjusted radial acceleration signal corresponding to a passage of said crown portion internally to a footprint portion of said tyre by a difference between said radial acceleration signal in said respective sub-portion and said adjustment factor.

In a third embodiment, the method preferably comprises:
identifying, in said radial acceleration signal, a respective sub-portion of said radial acceleration signal corresponding to a passage of said crown portion internally to a footprint portion of said tyre;
calculating a further average value of said radial acceleration signal in said respective sub-portion;
obtaining an average value of an adjusted radial acceleration signal in a sub-portion corresponding to a passage of said crown portion internally to a footprint portion of said tyre by a difference between said further average value of said radial acceleration signal in said respective sub-portion and said adjustment factor.

The method preferably comprises (regardless of the chosen embodiment) calculating a comparison parameter as a function of an (said) average value of said adjusted radial acceleration signal in said sub-portion.

The method preferably comprises (regardless of the chosen embodiment) detecting said aquaplane condition of said tyre as a function of a comparison between said comparison parameter and at least one threshold value.

According to another aspect, the invention relates to a system for detecting an aquaplane condition of a tyre on a surface.

The system for detecting preferably comprises a monitoring device fixed on an inner surface of said tyre at a crown portion of said tyre and configured to acquire, during a rolling of said tyre on said surface with an angular speed, a radial acceleration signal of said crown portion of said tyre.

The system for detecting preferably comprises a processing unit in communication with said monitoring device.

Preferably, said processing unit is programmed for receiving said radial acceleration signal from said monitoring device.

Preferably, said processing unit is programmed for obtaining an adjustment factor representative of an (average) offset between said one or more acquired values of radial acceleration and respective current values of radial acceleration of said crown portion.

In a first embodiment, preferably, said processing unit is programmed for:
obtaining an adjusted radial acceleration signal by a difference between said radial acceleration signal and said adjustment factor;
identifying, in said adjusted radial acceleration signal, a sub-portion of said adjusted radial acceleration signal corresponding to a passage of said crown portion internally to a footprint portion of said tyre.

In a second embodiment, preferably, said processing unit is programmed for:
identifying, in said radial acceleration signal, a respective sub-portion of said radial acceleration signal corresponding to a passage of said crown portion internally to a footprint portion of said tyre;
obtaining a sub-portion of an adjusted radial acceleration signal corresponding to a passage of said crown portion internally to a footprint portion of said tyre by a difference between said radial acceleration signal in said respective sub-portion and said adjustment factor.

In a third embodiment, preferably, said processing unit is programmed for:
identifying, in said radial acceleration signal, a respective sub-portion of said radial acceleration signal corresponding to a passage of said crown portion internally to a footprint portion of said tyre;
calculating a further average value of said radial acceleration signal in said respective sub-portion;
obtaining an average value of an adjusted radial acceleration signal in a sub-portion corresponding to a passage of said crown portion internally to a footprint portion of said tyre by a difference between said further average value of said radial acceleration signal in said respective sub-portion and said adjustment factor.

Preferably (independently of the chosen embodiment), said processing unit is programmed for calculating a comparison parameter as a function of an (said) average value of said adjusted radial acceleration signal in said sub-portion.

Preferably (independently of the chosen embodiment), said processing unit is programmed for detecting said aquaplane condition of said tyre as a function of a comparison between said comparison parameter and at least one threshold value.

According to a further aspect, the invention relates to a vehicle equipped with tyres comprising the system for detecting according to the present invention.

The term “average value” referred to the acquired radial acceleration signal means the average of the radial acceleration values of the crown portion acquired by the sensor within a given acquisition interval. The average can be, for example, an arithmetic mean or a weighted mean (for example, with weights distributed according to a Gaussian distribution).

According to the Applicant, the sub-portion of the adjusted radial acceleration signal corresponding to the passage of the crown portion within the footprint portion is particularly advantageous for detecting the aquaplane condition. In fact, without wishing to limit itself to any particular theory, the Applicant observes that in the footprint portion, the radial acceleration of the crown portion is essentially zero, and thus the average value of the acceleration signal in the sub-portion is also essentially zero, regardless of the rotational speed of the tyre. This is because the footprint portion, being in contact with the surface, has (substantially) zero curvature, and thus also (substantially) zero radial acceleration.

On the other hand, the Applicant has also found that the above statement regarding the cancellation of the radial acceleration values of the crown portion when in the footprint portion, which is perfectly valid in the case of a tyre rolling on a dry surface or in any case with a marginally thin water layer, does not hold true in the presence of an aquaplane condition of the tyre on the surface. For example, in the case of a complete aquaplane condition of the tyre, meaning a condition where the tyre is completely lifted from the surface by the interposed water layer between the surface and the tyre, the radial acceleration of the crown portion at the footprint location is not zero, and thus the corresponding average value of the acceleration signal in the sub-portion is also different from zero.

Therefore, the Applicant has found that, by comparing the average value of the adjusted radial acceleration signal in the sub-portion with at least one threshold value, it is particularly advantageous, for example in terms of simplicity of detection and/or calculation, to verify the offset of the average value from zero when the crown portion is in the footprint area, and thus detect the said aquaplane condition.

In this context, the Applicant has observed that, on the one hand, it is advantageous to acquire the radial acceleration signal using the said monitoring device fixed to the internal surface of the tyre for optimal and precise detection of the radial acceleration of the crown portion (precisely because the device itself is securely fixed directly to that crown portion).

On the other hand, however, the radial acceleration signal acquired by the said monitoring device is subject to an offset with respect to the actual radial acceleration values of the crown portion.

This offset is due to the offset value contribution of the acceleration sensor (or sensors) typically equipped in the said monitoring device. In summary, the offset value is the default value returned by the acceleration sensor when there is no acceleration, at least along the radial component, of the tyre (non-rolling tyre).

It follows that, due to the presence of such contribution of the offset value, the acquired radial acceleration signal is rigidly shifted entirely toward higher or lower values (translation along the y-axis, for example, in an acceleration/time graph). As a result, (in the absence of appropriate processing by the adjustment factor), the average value of the acquired signal in a respective sub-portion corresponding to the passage of the crown portion into the footprint portion is shifted from zero, without this shift actually corresponding to a real aquaplane condition of the tyre. This would thus lead to the risk of encountering false positive or false negative results in detecting the aquaplane condition.

According to the Applicant, therefore, since the aquaplane condition is detected by evaluating any deviation from zero of the average value of the signal in the sub-portion, it is essential to minimize, or even completely eliminate, the risk that such a deviation of the average value is due to a measurement error caused by the offset value contribution rather than a real aquaplane condition.

Furthermore, the Applicant has further observed that the contribution from the offset value can also vary over time, for example, as a result of progressive drift due to specific operating temperatures and/or working conditions, aging, etc., and in an unpredictable manner, both in terms of the timing of the variation and the magnitude of such variation, leading to a further deterioration in the reliability of the acquired acceleration signal.

According to the Applicant, therefore, obtaining (e.g., through one or more of the methodologies described below) the aforementioned adjustment factor, which represents the offset (for example, a mean value of the offset) between the one or more acquired values of radial acceleration and the respective current values of radial acceleration of said portion of the crown, allows for obtaining a quantity representative of, if not in certain cases directly coincident with, the aforementioned contribution from the offset value to the acquired signal, and thus enabling the monitoring of this contribution and its respective variations over time.

Finally, obtaining the adjusted radial acceleration signal by subtracting the acquired signal and the adjustment factor thus allows for the elimination, from the acquired signal, of the contribution due to the offset value (and any of its variations), thereby reducing, if not eliminating, the risk of false positives or false negatives in detecting the aquaplane condition, in order to achieve the desired detection reliability.

With regard to the first, second, and third embodiments of the method and, respectively, the system according to the present invention, the Applicant observes that they represent three entirely equivalent alternatives in terms of solving the aforementioned proposed problem. The steps described therein are, in fact, equivalent for the purpose of processing the acquired signal to obtain the average value of the adjusted radial acceleration signal in the sub-portion, from which the aforementioned comparison parameter is then calculated. For example, from a signal processing perspective, obtaining the adjusted signal by subtracting the entire acquired signal and the adjustment factor, then identifying the sub-portion in the adjusted signal and calculating the average value of the adjusted signal in the sub-portion (first embodiment), is entirely equivalent to identifying the respective sub-portion of the acquired signal, obtaining the sub-portion of the adjusted signal by subtracting the acquired signal only in the respective sub-portion and the adjustment factor, and then calculating the average value of the adjusted signal in the sub-portion (second embodiment). Similarly, the same applies to the description related to the third embodiment with reference to the first and second embodiments.

The present invention, in one or more of the aforementioned aspects, may feature one or more of the following preferred characteristics.

Preferably, said processing unit is programmed for performing one or more of the following operations preferably provided for the method according to the present invention.

Preferably, said comparison parameter is calculated as a function of a ratio between said respective average value of the adjusted radial acceleration signal in said sub-portion and an angular speed squared of said tyre. In this way, the comparison parameter is normalized with respect to the angular velocity of the tyre and thus independent of the rotational speed of the tyre. This simplifies the detection of the aquaplane condition, as for example, it is possible to keep at least one threshold value constant as the angular velocity of the tyre changes.

Preferably, detecting said aquaplane condition comprises detecting a first or a second aquaplane condition if said comparison parameter is less than or greater than respectively a second threshold value or a first threshold value, respectively. According to the Applicant, it is advantageously possible to detect two distinct aquaplane conditions using a single comparison parameter.

In one embodiment, said first threshold value is greater than said second threshold value. Preferably, said first threshold value is greater than zero. Preferably, said second threshold value is less than zero. These characteristics referring to the threshold values have been found particularly suitable for detecting the first and second aquaplane conditions of the tyre (as described below).

Preferably, obtaining said adjusted radial acceleration signal comprises subtracting said adjustment factor from each of said one or more acquired radial acceleration values. Preferably, said adjusted radial acceleration signal comprises one or more, more preferably a plurality of, adjusted values of radial acceleration. Preferably, each adjusted radial acceleration value is calculated by the difference between a respective acquired radial acceleration value and said adjustment factor. In this way, the adjusted signal is obtained in a simple and direct manner. For example, the radial acceleration signal and the adjusted radial acceleration signal are digital signals.

Preferably, said adjustment factor is calculated according to the following formula:

Af=ASavg+w2R*

In the above formula, ASavg is a respective average value of the radial acceleration signal, w is the angular speed of said tyre, and R* is a parameter representative of a radius of said tyre. In the above third embodiment of the method (and system) according to the present invention, said further average value of the radial acceleration signal in the respective sub-portion is distinct from said respective average value of the radial acceleration signal ASavg. According to the Applicant, in fact, estimating the offset value of the acceleration sensor is complex, especially in real conditions with tyres equipped with sensors and sold on various types of vehicles. A theoretical solution to this problem could be provided by performing a new calibration routine of the sensor to estimate the new offset value. From a practical point of view, however, the Applicant has found that such a sensor calibration routine is not feasible, as it would require, for each tyre equipped with a sensor placed on the market, periodic returns of the tyre to a laboratory for performing the new calibration routine. Furthermore, even if such a new calibration routine were carried out, it would not be entirely effective, as the offset value deviation phenomenon could reappear even shortly after calibration, rendering it of little practical use. According to the Applicant, the calculation of the adjustment factor according to the formula described above is particularly advantageous, as it allows for obtaining, during the normal operation of the tyre and potentially as often as desired (even at each full rotation of the tyre), a precise, reliable, and always up-to-date estimate of the contribution of the offset value to the raw, acquired radial acceleration signal, using easily obtainable quantities and without necessarily needing to directly calculate the offset value. This method is thus robust even in the face of any changes in the offset value over time and avoids the aforementioned practical issues related to performing new calibration routines.

Preferably, said respective average value of the radial acceleration signal is calculated by arithmetic mean.

Preferably, providing said monitoring device comprises arranging at least one sensor suitable for detecting at least one radial component of an overall acceleration of said crown portion of said tyre.

Preferably, said monitoring device comprises said sensor. For example, the sensor is encapsulated in a containment body of the monitoring device, where said containment body is fixed to said inner surface of the tyre. The sensor, typically after being encapsulated in the containment body, may be disposed at a certain distance (e.g., around one centimeter) from the inner surface of the tyre.

In one embodiment, said method comprises calculating said parameter representative of the radius of said tyre as a function of a geometric radius (internal, i.e., between a centre of rotation of the tyre and said inner surface) of said tyre and said distance between said inner surface of said tyre and said sensor. In this way, the calculation of the representative parameter involves reduced computational effort, as it involves quantities that can be considered constant.

Preferably, said parameter representative of the radius is calculated by subtracting said distance between the inner surface of the tyre and the sensor from said geometric radius. In this way, the calculation is simple and direct.

In one embodiment, the method comprises estimating said parameter representative of the radius of said tyre as a function of one or more of the following operative parameters: vertical load acting on said tyre, inner pressure of said tyre, and the angular speed of said tyre. In this way, a high-precision estimate of the representative radius parameter can be obtained.

Preferably, acquiring said radial acceleration signal is performed within an acquisition window comprising at least a portion of a complete rotation of said crown portion around an axis of rotation of said tyre, for which said crown portion lies externally to said footprint portion of said tyre. In other words, the radial acceleration signal is preferably acquired also during a time interval or angular interval corresponding to a fraction of the full rotation, during which the crown portion is outside the footprint of the tire (in addition to a time or angular interval corresponding to the aforementioned passage of the crown portion within the footprint, so that this passage is also present in the adjusted signal). In this way, the accuracy of the acquired radial acceleration signal is improved for the calculation of the respective average value ASavg, as the radial acceleration of the crown portion is acquired when in free rotation, i.e., not subject to any disturbances associated with passing through the footprint.

Preferably, said method comprises calculating said respective average value of the radial acceleration signal at least in said portion of said acquisition window. In this way, the calculation of the respective average value ASavg is improved, for example, by eliminating the disturbances associated with passing through the footprint area.

Preferably, said method comprises calculating said respective average value of the radial acceleration signal over a whole extent of said acquisition window. This simplifies the calculation and does not require special measures. The Applicant has indeed realized that the potential disturbances associated with the passage of the crown portion through the footprint area can be mitigated by acquisitions performed outside the footprint area.

Preferably, said acquisition window corresponds to at least half of said complete rotation of said crown portion, more preferably it corresponds to an entire full rotation of the crown portion. In this way, the acquisition is extremely simple and does not require any additional interventions (for example, to discriminate whether the crown portion is inside or outside the footprint portion).

Preferably, said acquisition window is centered on said passage of said crown portion internally to the footprint portion of said tyre. In this way, the identification of the sub-portion in the adjusted signal is advantageously simplified.

In one embodiment, said average value of the adjusted radial acceleration signal in the sub-portion is calculated using a weighted average with weights defined according to a Gaussian or Normal distribution. In this way, the accuracy of the aquaplane condition detection is improved. For example, by assigning greater weight to the adjusted radial acceleration values positioned centrally in the sub-portion compared to the extreme values, any signal disturbances caused by the passage of the crown portion at the edges of the footprint portion are eliminated.

Preferably, said method comprises adjusting, based on the detected aquaplane condition, a control apparatus of said vehicle, for example, an ABS system of the vehicle or a traction control system. In this way, the vehicle can be controlled in a feedback manner, greatly enhancing safety.

Preferably, said acquisition window is repeated in each complete rotation of said tyre.

Preferably, for each complete rotation of said tyre, said method comprises repeating:
acquiring a radial acceleration signal of the crown portion;
obtaining an adjustment factor representative of an offset between said one or more acquired values of radial acceleration and respective current values of radial acceleration of said crown portion; obtaining an adjusted radial acceleration signal by a difference between said radial acceleration signal and said adjustment factor;
identifying, in said adjusted radial acceleration signal, a sub-portion of said adjusted radial acceleration signal corresponding to a passage of said crown portion internally to a footprint portion of said tyre;
calculating a comparison parameter as a function of an average value of said adjusted radial acceleration signal in said sub-portion;
detecting said aquaplane condition of said tyre as a function of a comparison between said comparison parameter and at least one threshold value. In this way, the method dynamically updates, proving to be highly versatile.

### BRIEF DESCRIPTION OF THE FIGURES

FIG. 1 schematically shows a vehicle according to the present invention;

FIG. 2 schematically shows a detail of the vehicle of FIG. 1;

FIG. 3 schematically shows a section of FIG. 2;

FIG. 4 shows a block diagram of the phases of a first embodiment of a method for detecting according to the present invention;

FIG. 5 shows in detail a respective logical block of the diagram in FIG. 4;

FIG. 6 shows an application of the method according to the present invention;

FIG. 6b shows a schematic of a tyre rolling on a surface;

FIGS. 7 and 8 show some exemplary applications of the method according to the present invention.

### DETAILED DESCRIPTION OF SOME EMBODIMENTS OF THE INVENTION

The features and advantages of the present invention will be further clarified by the following detailed description of some embodiments, presented by way of example and not as a limitation of the present invention, with reference to the attached figures.

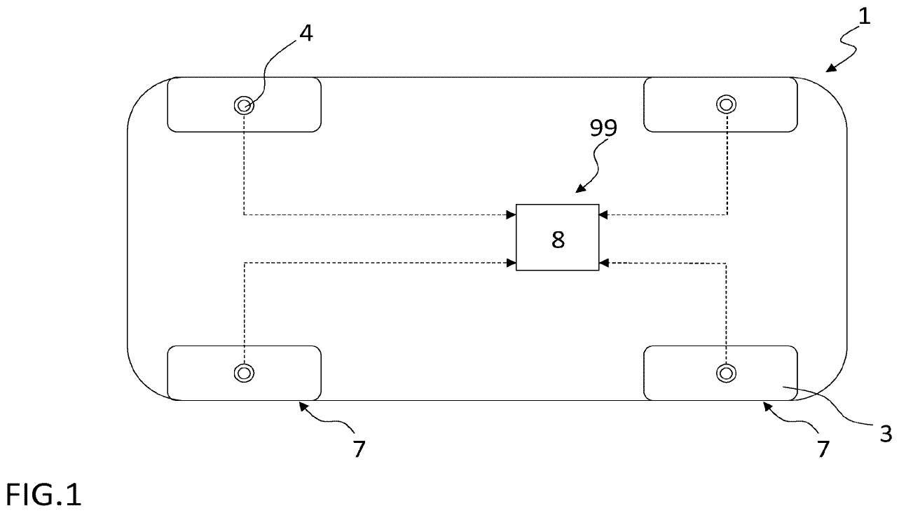

FIG. 1 schematically shows a vehicle 1 according to the present invention. The vehicle 1 can be a vehicle with an internal combustion engine and/or electric motor, with two or more driven wheels.

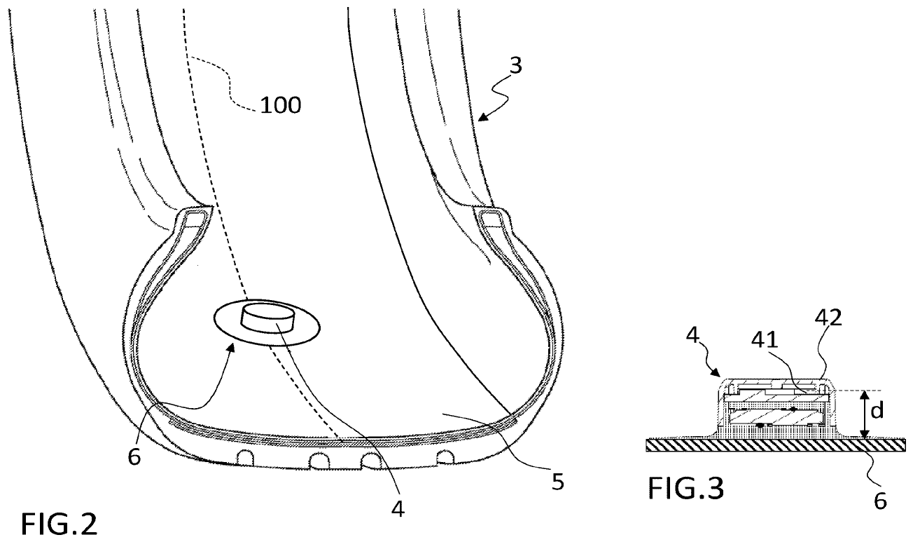

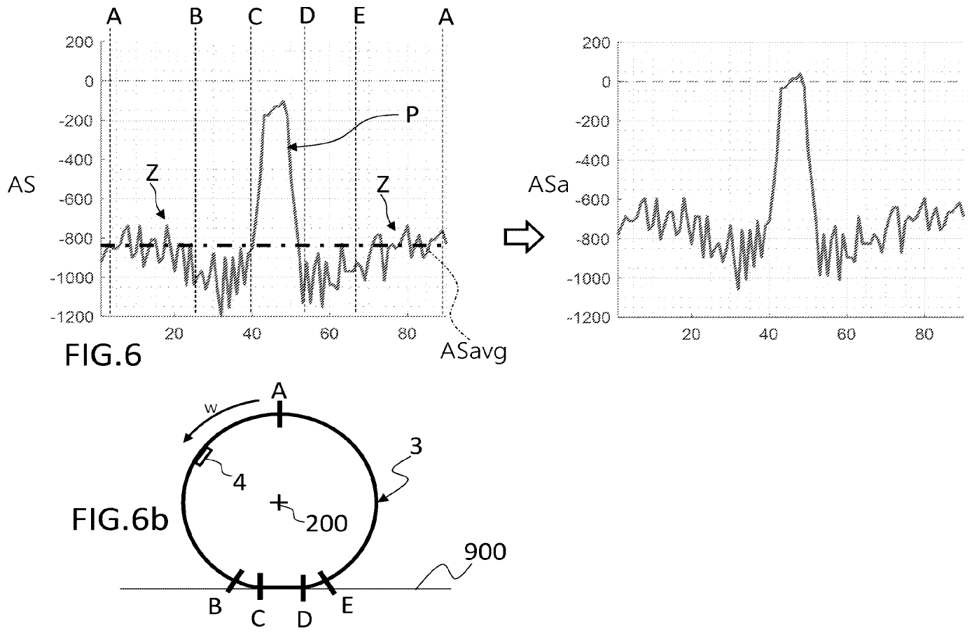

Exemplarily the vehicle 1 comprises four wheels 7 (distributed over two axles), each equipped with a respective tyre 3 (partially shown also in FIG. 2) rolling on a surface 900 (shown in FIGS. 6b, 7, and 8). In one embodiment (not shown), the vehicle may have three or more axles.

The vehicle 1 exemplarily comprises a system for detecting 99 an aquaplane condition of a tyre 3 with surface 900. Exemplarily the system for detecting 99 is capable of detecting a respective aquaplane condition of each tyre 3 of vehicle 1 with surface 900.

The system 99 exemplarily comprises a monitoring device 4 for each tyre 3 (FIGS. 1, 2, and 3). For example, the monitoring device 4 may be of the type described in one of the following documents in the name of the same Applicant: WO 2018/065846 A1, WO 2019/123118 A1, WO 2020/026281 A1, WO 2020/026282 A1.

Exemplarily, each monitoring device 4 is fixed to an inner surface 5 of the respective tyre 3, at a crown portion 6 of the respective tyre 3 (FIGS. 2 and 3). In particular, the monitoring device 4 may be fixed to a liner of the tyre 3, typically by gluing (for example by means of a structural adhesive or pressure-sensitive adhesive-PSA). Preferably, the monitoring device 4 can be fixed substantially at the equatorial plane 100 of the tyre 3. Further monitoring devices (not shown) can be arranged in more lateral position on the inner surface of the tyre 3, and/or at different angular positions along the inner circumference of the tyre 3.

Exemplarily, the crown portion 6 coincides with a portion of the tyre located at the tread area and substantially underlies a base surface of the monitoring device (i.e., the surface through which the device is fixed to the inner surface 5, FIG. 3).

Optionally, the crown portion can be identified as a portion of the tyre with a greater extension than the base surface of the monitoring device.

Exemplarily each monitoring device 4 is configured to acquire, during a rolling of the respective tyre 3 on the surface with an angular speed w, a radial acceleration signal AS of the crown portion 6 of the tyre 3. In detail, each monitoring device 4 exemplarily comprises a respective sensor 41 (schematically shown in FIG. 3) suitable for detecting at least one radial component of an overall acceleration of the crown portion 6 of the tyre 3.

The system for detecting 99 also exemplarily comprises a processing unit 8 (shown only schematically in FIG. 1) in communication with each monitoring device 4, for example, via a radio signal and/or wired connection. The processing unit may be installed on board the vehicle or directly integrated into one or more of the monitoring devices 4, or even within the sensor 41. Hybrid hardware and/or software solutions may also be provided, comprising one or more of the aforementioned alternatives.

In use, the system for detecting 99 allows for performing a method for detecting an aquaplane condition of a tyre 3 with surface 900 according to the present invention, typically through one or more hardware devices programmed via one or more software modules resident and/or loaded onto appropriate memory.

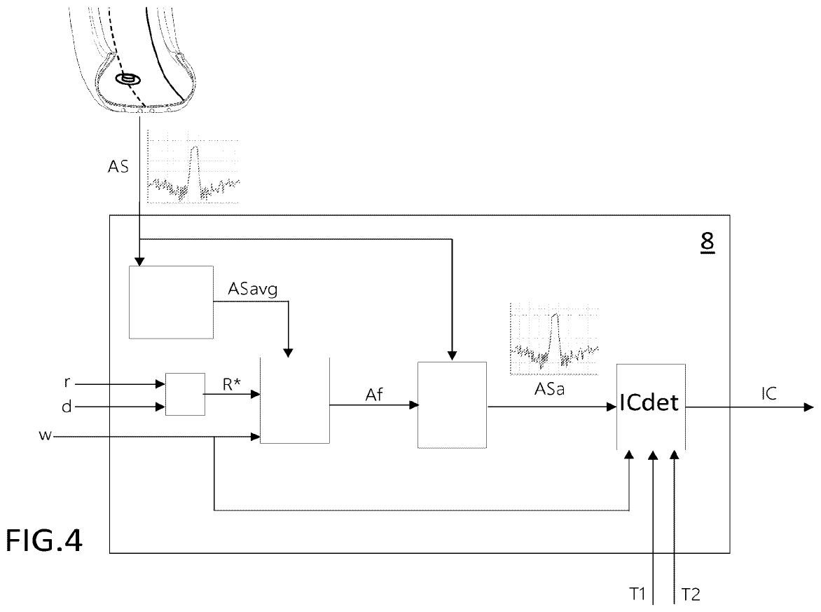

A first embodiment of the detection method according to the present invention will be described below with reference to FIGS. 4-8. The following description will be made with reference to a given tyre 3 equipped with the respective monitoring device 4, but it can be conceptually extended to each of the tyres 3 of vehicle 1.

First, the method exemplarily comprises acquiring, during the rolling of tyre 3 on surface 900 at angular speed w, the radial acceleration signal AS of the crown portion 6 of tyre 3, through the monitoring device 4 associated with the given tyre. Exemplarily, the processing unit 8 is programmed to receive the radial acceleration signal AS from the monitoring device 4.

Exemplarily, the radial acceleration signal AS comprises a plurality of acquired values of radial acceleration of the crown portion of the tyre. For example, the radial acceleration signal AS is a digital signal. A graphical example of the radial acceleration signal AS is shown in FIG. 6, where the radial acceleration in m/s² is represented on the y-axis, and the progressive sampling number is shown on the x-axis. Alternatively (not shown), the radial acceleration signal AS can be graphed as a function of time or rotation degrees relative to a full rotation (e.g., an angular range between 0°-360°, or the entire full rotation).

Exemplarily, not shown, the radial acceleration signal AS can be obtained after analog-to-digital conversion of a corresponding analog signal produced by sensor 41, optionally appropriately processed (e.g., using a calibration curve) to obtain a vector of acquired radial acceleration values expressed in m/s². Alternatively, the acquired signal AS can be expressed in a scale of pure integer numbers.

Exemplarily, acquiring the radial acceleration signal AS is performed in an acquisition window corresponding to a complete rotation of the crown portion 6 around the rotation axis 200 of the tyre (i.e., in a full rotation of the monitoring device 4 around the rotation axis 200 of the tyre 3).

Exemplarily the shape of the radial acceleration signal AS obtained and shown in FIG. 6 includes a peak P where the radial acceleration values approach zero, and two tails Z, positioned on opposite sides of the peak P.

The tails Z of the radial acceleration signal AS correspond, each or globally, to a portion of a full rotation of the crown portion 6 around the rotation axis 200 of the tyre 3 in which the crown portion 6 lies externally to the footprint portion of the tyre 3. Exemplarily, the footprint portion corresponds to the section C-D in FIG. 6b (with corresponding letters also shown in FIG. 6), and the tails Z correspond respectively to the sections A-B and E-A in FIGS. 6 and 6b.

Exemplarily, with reference to FIGS. 6 and 6b, the peak P of the radial acceleration signal AS corresponds to a passage of the crown portion 6 internally to the footprint portion C-D of the tyre 3. Exemplarily, the peak P thus corresponds to an additional portion of the full rotation of the crown portion 6 around the rotation axis 200 of the tyre 3 in which the crown portion 6 lies internally to the footprint portion C-D of the tyre 3.

The remaining portions of the radial acceleration signal AS, exemplarily corresponding respectively to segments B-C and D-E in FIGS. 6 and 6b, correspond to transition regions that can be defined as entry and exit regions from the footprint portion C-D. Conceptually, these transition regions can be considered as part of the aforementioned first portion of the full rotation of the crown portion 6. Exemplarily, the first and second portions of the full rotation of the crown portion 6 are thus contiguous to each other.

Exemplarily, the acquisition window is centered on the passage of the crown portion 6 inside the footprint portion C-D of the tyre 3.

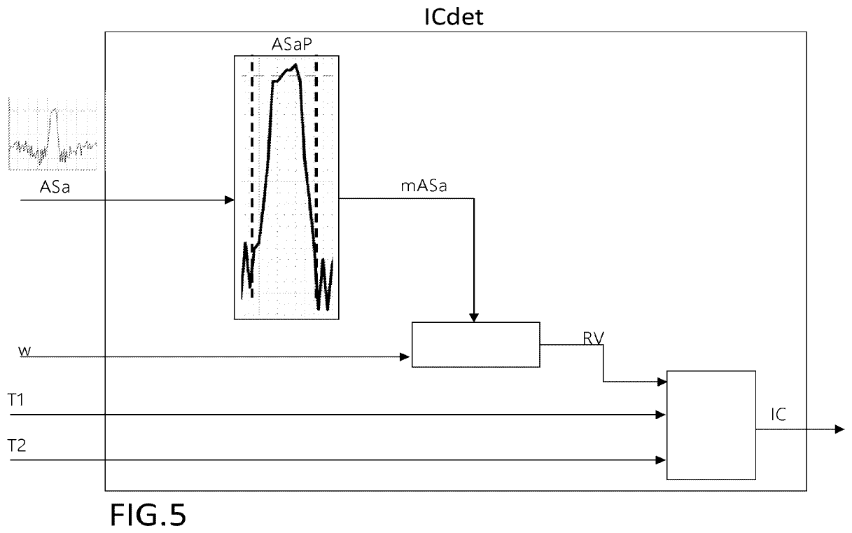

Exemplarily, the processing unit 8 is programmed to perform the following operations provided for the method for detecting, symbolically depicted in FIG. 4 and, in detail, in FIG. 5.

Exemplarily, the method thus comprises obtaining an adjustment factor Af representative of an offset between the one or more acquired values of radial acceleration and the respective current values of radial acceleration of the crown portion, that is, the actual values of radial acceleration of the crown portion. As described above, due to possible random phenomena of progressive drift in the operating conditions of the acceleration sensor 41 compared to the factory conditions, the aforementioned two sets of values, namely the acquired values and the current (actual) values, may differ from each other.

In detail, exemplarily, the method comprises calculating the adjustment factor Af according to the following formula:

Af=ASavg+w2R*
where ASavg is a respective average value of the radial acceleration signal AS, w is the angular velocity of the tyre 3, and R* is a parameter representative of a radius of the tyre 3.

Exemplarily, the respective average value ASavg of the radial acceleration signal AS is calculated as the arithmetic mean of the acquired radial acceleration values. Exemplarily, the respective average value ASavg is calculated over the whole extent of the acquisition window. The Applicant has indeed observed that the presence of the peak P in the acquired radial acceleration signal does not significantly affect the calculation of the respective average value (as also shown in FIG. 6), which can therefore be performed over the entire acquisition window, advantageously avoiding the need for a routine to identify at least the peak region P in the acquired signal AS (for example, to exclude it, preferably along with the aforementioned transition regions, from the calculation of the respective average value ASavg). Alternatively, such a routine for identifying the peak region P may be provided, and the respective average value ASavg may be calculated in a part of the acquisition window that includes (or corresponds to) the first portion (i.e., the Z tails of the signal AS).

Exemplarily, the method also comprises calculating the parameter R* representative of the radius of the tyre 3 as a function of a geometric (internal) radius r (not shown) of the tyre 3 and a distance d between the inner surface 5 of the tyre and the sensor 41 (FIG. 3), more specifically by the difference between the geometric radius r and the distance d (i.e., R*=r−d). Indeed, the sensor 41 is encapsulated in a containment body 42 of the monitoring device 4, where the containment body 42 is fixed to the inner surface 5 of the tyre 3. The sensor 41, as a result of encapsulation in the containment body, is for example disposed at the said distance d from the inner surface 5.

In an embodiment (not shown), the method includes estimating the parameter representative of the radius of the tyre as a function of one or more of the following operational parameters: vertical load acting on the tyre, inner tyre pressure, angular speed of the tyre. For example, the estimation of the parameter representative of the radius may involve performing a plurality of tests on one or more tyres of the same type as the tyre mounted on the vehicle, where each test is performed on a respective tyre with a predetermined value of one or more of the aforementioned operational parameters. Preferably, it is also provided to determine the value of the parameter representative of the tyre radius based on the results of the said plurality of tests, for example using linear regression methodologies. Alternatively (not shown), the adjustment factor can be calculated as follows:
Verify that the vehicle is stationary;
Acquire a respective radial acceleration signal, with the respective radial acceleration signal comprising one or more respective acquired values of radial acceleration;
Calculate the adjustment factor based on the difference from zero of the one or more respective acquired values of radial acceleration.

Exemplarily, to calculate the adjustment factor, it is advantageous to calculate an average value (e.g., arithmetic mean) of the respective acquired radial acceleration values (when there is more than one) and then calculate the difference between this average value and zero. Alternatively, in a mathematically equivalent way, it can be foreseen to calculate the difference of each respective acquired value of radial acceleration and then compute the arithmetic mean of the differences.

For example, verifying that the vehicle is stationary may include detecting the angular speed w of one or more tires of the vehicle and determining the absence of motion of the vehicle based on a comparison between the angular speed and a reference value. If the angular speed is zero, then the vehicle is stationary, and the respective acquired values of the radial acceleration signal should be zero (net of the gravitational acceleration projected along the sensor's measurement direction). In this case, any difference in the respective acquired values from zero would represent the contribution of drift phenomena, such as an offset variation.

For example, to detect the angular speed w, a signal may be used that does not come from the monitoring devices 4 of the tyres, but rather from the CAN of the vehicle, which is typically installed in all vehicles. The CAN of the vehicle will not be described in further detail, as it is of a known type, for instance, commonly used for transmitting data between various control units of the vehicle.

In an additional example, verifying that the vehicle is stationary may involve acquiring, through one or more monitoring devices 4 (e.g., using the sensor 41), the respective radial acceleration signal of the vehicle for a predetermined time interval and determining the absence of motion by evaluating whether the acquired signal remains constant over the predetermined time interval. Indeed, if the radial acceleration remains constant, then there is no passage of the crown portion into the footprint portion (and thus no peak PP in the respective acquired radial acceleration signal), allowing one to conclude that the vehicle is stationary because there is no rotation of the tyres. In this case, any difference between the acquired values and zero does not represent a real condition of the tyre, but rather a contribution from drift phenomena, which can thus be estimated and eliminated.

The method exemplarily comprises obtaining an adjusted radial acceleration signal ASa by means of a difference between the radial acceleration signal AS and the adjustment factor Af. In detail, it is exemplarily provided to obtain the adjusted radial acceleration signal ASa as a digital signal comprising a vector whose individual values, called adjusted radial acceleration values, are calculated each by means of the difference between a respective acquired value of radial acceleration of the acquired radial acceleration signal AS and the adjustment factor Af.

An example of an adjusted radial acceleration signal ASa is exemplarily shown on the right side of FIG. 6 (on the y-axis, the radial acceleration values are shown in m/s², on the x-axis, the sampling values are shown). As can be observed, the adjusted radial acceleration signal ASa is identical to the acquired radial acceleration signal AS, except for a rigid translation towards higher radial acceleration values. The amplitude of this translation corresponds to the contribution given to the signal by the offset value of the sensor 41. The Applicant has realized that the adjustment factor Af as calculated above is representative of this contribution given by the offset value, while at the same time eliminating the need to directly calculate this contribution (which is generally unknown due to random and unpredictable phenomena of variation of such an offset value).

The adjusted radial acceleration signal ASa obtained by the difference between each acquired value of radial acceleration and the adjustment factor Af is therefore cleansed of the contribution from the offset value, and thus independent of such offset value and any corresponding variation over time. It can be observed that the adjusted radial acceleration signal ASa reaches values close to zero at the respective peak, as correctly expected (since the radial acceleration of the footprint portion is zero).

The subsequent steps of the method will now be described with particular reference to the ICdet routine and FIG. 5.

Exemplarily, the method comprises identifying, in the adjusted radial acceleration signal ASa, a sub-portion ASaP of the adjusted radial acceleration signal ASa corresponding to the passage of the crown portion 6 internally to the footprint portion C-D of the tyre 3. Exemplarily, the sub-portion ASaP corresponds to the peak of the adjusted radial acceleration signal ASa (which in turn corresponds to the peak P of the acquired radial acceleration signal AS, except for the aforementioned rigid translation).

Exemplarily, the method therefore comprises calculating a comparison parameter RV as a function of an average value mASa of the adjusted radial acceleration signal ASa in the sub-portion ASaP.

In one embodiment, the average value mASa of the adjusted radial acceleration signal ASa in the sub-portion ASaP may be calculated by means of a weighted average of the adjusted radial acceleration values of the adjusted radial acceleration signal ASa in the sub-portion ASaP, with weights distributed according to a Gaussian or Normal distribution.

Alternatively, the average value mASa may be calculated by a weighted average with weights distributed differently from a Gaussian distribution, or by means of an arithmetic average.

Exemplarily, the method therefore comprises detecting the aquaplane condition IC as a function of a comparison between the comparison parameter RV and at least one threshold value.

In detail, the comparison parameter RV is exemplarily calculated as a function of a ratio between the mean value mASa of the adjusted radial acceleration signal ASa in the sub-portion ASaP and the square of the angular speed w of the tyre 3.

The comparison parameter RV calculated in this way is therefore zero if mASa is zero, positive if mASa is positive, and negative if mASa is negative (since w2 in the denominator is always a positive value).

Detecting the aquaplaning condition IC exemplarily comprises detecting a first or second aquaplaning condition if the comparison parameter RV is less than or greater than a second threshold value T2 or a first threshold value T1, respectively. In detail, the first threshold value T1 is greater than zero, and the second threshold value T2 is less than zero. For example, the first threshold value T1 and the second threshold value T2 are respectively equal to +0.05 and −0.05.

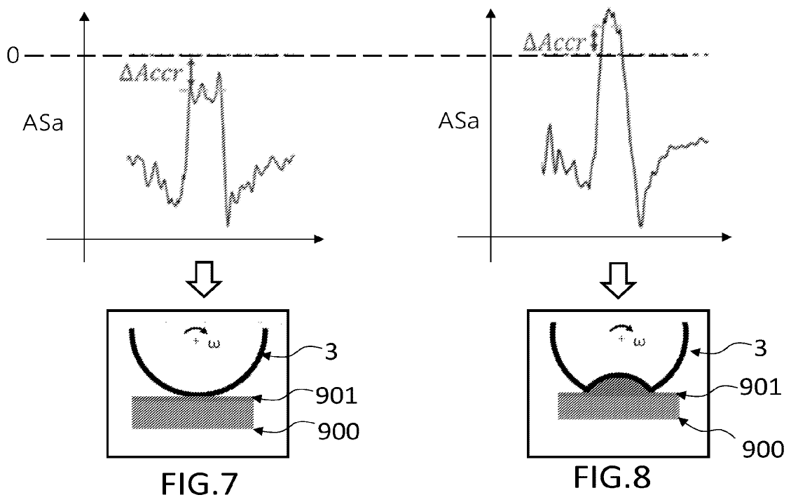

Exemplarily, detecting the first aquaplaning condition occurs when the comparison parameter RV is less than the second threshold value T2, i.e., RV<T2 (in this example, RV<−0.05). This first aquaplaning condition corresponds physically to the situation shown in FIG. 7, i.e., a total aquaplaning condition of the tyre where the tyre is completely lifted off the surface 900 by a layer of water 901 placed between the surface 900 and tyre 3, but where the combination of the rolling motion of the tyre and the characteristics of the water layer is such that it does not compress the tyre in the same way as a dry surface would. Therefore, the tyre is deformed in the contact area, but with a deformation different from that on a dry surface (for simplicity, in FIG. 7 the tyre is shown as essentially circular, although in reality, some deformation in the contact area is still present).

In this situation, the Applicant has observed that the adjusted radial acceleration signal ASa still exhibits a peak, as shown in FIG. 7, but it settles around values less than zero (with the difference from zero denoted as ΔAccr in FIG. 7), resulting in a respective average value mASa less than zero (and thus RV less than zero). The second threshold value of −0.05 is useful for distinguishing any background noise present in the acquired signal AS (and thus in the adjusted signal ASa).

Exemplarily detecting the second aquaplaning condition occurs when the comparison parameter RV is greater than T1, i.e., RV>T1 (in this example, RV>+0.05). This second aquaplaning condition corresponds physically to the situation shown in FIG. 8, i.e., a respective total aquaplaning condition of tyre 3, where the tyre is completely lifted off the surface 900 by the water layer 901 placed between surface 900 and tyre 3, and where the combination of the rolling motion of the tyre and the characteristics of the water layer causes a compression of the tyre greater than that from the surface, such that the lower portion of the tyre becomes significantly deformed (even inwardly bent) and thus is no longer flat as it would be on a dry surface. In this situation, the Applicant has observed that the adjusted radial acceleration signal ASa shows a peak pattern as shown in FIG. 8, i.e., with a peak that reaches radial acceleration values greater than zero (with the difference from zero denoted as ΔAccr in FIG. 8), resulting in a respective average value mASa greater than zero (and thus RV greater than zero). The first threshold value, exemplarily set at +0.05, is useful for distinguishing any background noise present in the acquired signal AS (and thus in the adjusted signal ASa).

It is observed that the removal of the deviation between the one or more acquired values of radial acceleration and the respective current values of radial acceleration of the crown portion 6, performed by subtracting the radial acceleration signal AS and the adjustment factor Af, proves to be particularly advantageous and synergistic for detecting an aquaplaning condition since, by removing the contribution of the offset value and any corresponding variations, it becomes possible to conclude with the desired precision and reliability that a deviation in the average value mASa of the adjusted radial acceleration signal ASa within the sub-portion ASaP (FIGS. 7 and 8) is indeed due to a given aquaplaning condition of the tyre (and not to measurement error introduced by the offset value).

Optionally, it may finally be provided to adjust a control system (not shown) of the vehicle 1, such as an ABS system and/or a traction control system, as a function of the detected aquaplaning condition IC (for example, as a function of the first and/or second aquaplaning condition).

1-18. (canceled)

19. A method for detecting an aquaplane condition of a tyre on a surface, the method comprising:
providing a monitoring device fixed on an inner surface of the tyre at a crown portion of the tyre;
acquiring, during a rolling of the tyre on the surface with an angular speed, a radial acceleration signal of the crown portion of the tyre by the monitoring device, wherein the radial acceleration signal comprises one or more acquired values of radial acceleration of the crown portion of the tyre;
obtaining an adjustment factor representative of an offset between the one or more acquired values of radial acceleration and respective current values of radial acceleration of the crown portion;
obtaining an adjusted radial acceleration signal by a difference between the radial acceleration signal and the adjustment factor;
identifying, in the adjusted radial acceleration signal, a sub-portion of the adjusted radial acceleration signal corresponding to a passage of the crown portion internally to a footprint portion of the tyre;
calculating a comparison parameter as a function of an average value of the adjusted radial acceleration signal in the sub-portion; and
detecting the aquaplane condition of the tyre as a function of a comparison between the comparison parameter and at least one threshold value.

20. The method according to claim 19, wherein the comparison parameter is calculated as a function of a ratio between the average value of the adjusted radial acceleration signal in the sub-portion and an angular speed squared of the tyre.

21. The method according to claim 19, wherein detecting the aquaplane condition comprises detecting a first or a second aquaplane condition if the comparison parameter is less than or greater than respectively a second threshold value or a first threshold value, wherein the first threshold value is greater than the second threshold value.

22. The method according to claim 19, wherein obtaining the adjusted radial acceleration signal comprises subtracting the adjustment factor from each of the one or more acquired values of radial acceleration.

23. The method according to claim 19, wherein the adjustment factor (Af) is calculated according to the following formula:
Af=ASavg+w2R*
wherein ASavg is a respective average value of the radial acceleration signal,
wherein w is the angular speed of the tyre,
wherein R* is a parameter representative of a radius of the tyre.

24. The method according to claim 23, wherein providing the monitoring device comprises arranging at least one sensor suitable for detecting at least one radial component of an overall acceleration of the crown portion of the tyre.

25. The method according to claim 24, further comprising calculating the parameter (R*) representative of the radius of the tyre as a function of a geometric radius of the tyre and of a distance between the inner surface of the tyre and the sensor.

26. The method according to claim 25, further comprising estimating the parameter (R*) representative of the radius of the tyre as a function of one or more of the following operative parameters: vertical load acting on the tyre, inner pressure of the tyre, and the angular speed of the tyre.

27. The method according to claim 26, wherein acquiring the radial acceleration signal is performed within an acquisition window comprising at least a portion of a complete rotation of the crown portion around an axis of rotation of the tyre for which the crown portion lies externally to the footprint portion of the tyre, and wherein the method comprises calculating the respective average value (ASavg) of the radial acceleration signal at least in the portion of the acquisition window.

28. The method according to claim 27, further comprising calculating the respective average value (ASavg) of the radial acceleration signal over a whole extent of the acquisition window.

29. The method according to claim 27, wherein the acquisition window corresponds to at least half of the complete rotation of the crown portion, and wherein the acquisition window is centred on the passage of the crown portion internally to the footprint portion of the tyre.

30. A method for detecting an aquaplane condition of a tyre on a surface, the method comprising:
providing a monitoring device fixed on an inner surface of the tyre at a crown portion of the tyre;
acquiring, during a rolling of the tyre on the surface with an angular speed, a radial acceleration signal of the crown portion of the tyre by the monitoring device, wherein the radial acceleration signal comprises one or more acquired values of radial acceleration of the crown portion of the tyre;
obtaining an adjustment factor representative of an offset between the one or more acquired values of radial acceleration and respective current values of radial acceleration of the crown portion ;
identifying, in the radial acceleration signal, a respective sub-portion of the radial acceleration signal corresponding to a passage of the crown portion internally to a footprint portion of the tyre;
obtaining a sub-portion of an adjusted radial acceleration signal corresponding to a passage of the crown portion internally to a footprint portion of the tyre by a difference between the radial acceleration signal in the respective sub-portion and the adjustment factor;
calculating a comparison parameter as a function of an average value of the adjusted radial acceleration signal in the sub-portion; and
detecting the aquaplane condition of the tyre as a function of a comparison between the comparison parameter and at least one threshold value.

31. A method for detecting an aquaplane condition of a tyre on a surface, the method comprising:
providing a monitoring device fixed on an inner surface of the tyre at a crown portion of the tyre;
acquiring, during a rolling of the tyre on the surface with an angular velocity, a radial acceleration signal of the crown portion of the tyre by the monitoring device, wherein the radial acceleration signal comprises one or more acquired values of radial acceleration of the crown portion of the tyre;
obtaining an adjustment factor representative of an offset between the one or more acquired values of radial acceleration and respective current values of radial acceleration of the crown portion;
identifying, in the radial acceleration signal, a respective sub-portion of the radial acceleration signal corresponding to a passage of the crown portion internally to a footprint portion of the tyre;
calculating a further average value of the radial acceleration signal in the respective sub-portion;
obtaining an average value of an adjusted radial acceleration signal in a sub-portion corresponding to a passage of the crown portion internally to a footprint portion of the tyre by a difference between the further average value of the radial acceleration signal in the respective sub-portion and the adjustment factor;
calculating a comparison parameter as a function of the average value of the adjusted radial acceleration signal in the sub-portion; and
detecting the aquaplane condition of the tyre as a function of a comparison between the comparison parameter and at least one threshold value.
